(19) United States
(12) Patent Application Publication
(10) Pub. No.: US 2005/0037127 A1
(43) Pub. Date: Feb. 17, 2005

(54) Novel fruit fillings, methods for their manufacture and their use in nutritional products

(75) Inventors: Frances Sault, Dorval (CA); Dennis Jones, Shelburne, VT (US)

Correspondence Address: HELLER EHRMAN WHITE & MCAULIFFE LLP, 1666 K STREET,NW, SUITE 300, WASHINGTON, DC, 20006, US

(73) Assignee: Nellson Northern Operating Inc

(21) Appl. No.: 10/501,469

(22) PCT Filed: Jan. 16, 2003
(86) PCT No.: PCT/US03/01169

Related U.S. Application Data
(60) Provisional application No. 60/348,638, filed on Jan. 17, 2002.
(60) Provisional application No. 60/353,988, filed on Feb. 5, 2002.

(51) Int. Cl. A23K 1/00

(52) U.S. Cl. 426/615

(57) ABSTRACT

A fruit filling containing pureed fruit and wheat gluten is described. A nutritional bar comprising such fruit filling also is described. Methods of producing the fruit filling and bar also are described.

This application claims priority from U.S. Provisional Application Nos. 60/348,638 and 60/353,988, filed Jan. 17, 2002 and Feb. 5, 2002, respectively, and incorporates both by reference.

### BACKGROUND OF THE INVENTION

1. Field of the Invention

The present invention relates to fruit filling products wherein wheat proteins are added to fruit fillings for any use but particularly for use in bars, particularly nutritional bars.

2. Description of Prior Art

While the use of caramels to create nutritional bars of two or more layers is generally known, the spectrum of organoleptic characteristics obtained by the use of such materials is generally quite limited, and cannot give rise to the diversity of products that the public might wish to see. Thus caramel, with its conventional flavor, may lend itself to layers which have a peanutty aspect, but attempts to create light fruity flavors are generally disappointing.

Such light fruity flavors in two-layer or in multiple-layer bars would be achievable by the use of gelled fruit preparations, broadly classified as fruit fillings, which include fruit jellies, purees or stiffened fruit preserves such as jams. However, such ingredients lack the physical properties required for stable confectionery products, particularly those products which are generally known as nutritional bars. In particular, fruit fillings do not cease to flow, and may be sticky, both properties which would bar them from utility as layers in multiple-layer bars.

The gelling that is a critical stage in manufacture of fruit fillings occurs because of the presence of pectin, a carbohydrate, which forms a gel structure in the presence of acid. Not all fruits contain sufficient pectin to ensure setting, and it is both industry and domestic practice, when making preserves, to assist the natural process by adding further pectin and often alginates, together with control of acidity. However, while such additives may result in a highly desirable preserve, capable of being used as a spread and with excellent mouth feel, they do not eliminate the properties of stickiness and flowability which hinder the use of these materials in two-layer or multiple-layer bars.

### SUMMARY OF THE INVENTION

A fruit filling comprising fruit puree and wheat gluten wherein said fruit puree comprises crushed fruit, pectin and sugar.

The invention further relates to such filling that comprises at least one additional ingredient, which would be known to those skilled in the art, including, but not limited to, water, citric acid, sodium citrate, calcium citrate, phosphates, sugars in the broadest sense of the word, including sugar alcohols such as glycerine, sorbitol, maltitol, xylitol and the like, alginates, colors, flavors, salt, emulsifiers and preservatives such as benzoates and sorbates.

The fruit puree of the filling comprises crushed fruit, pectin and sorbitol or fructose.

The filling of the invention may comprises deamidated wheat gluten.

The crushed fruit of the puree may be selected from the group consisting of blueberry, apple, apricot, peach, strawberry, blackberry, grape, cherry, and raspberry crushed fruit and such other fruits as will be obvious to those skilled in the art.

The filling of the invention may further comprise about 0 to 25 percent by weight of water, about 0 to 66 percent by weight of sugar, about 0 to 62 percent by weight of fruit, about 0 to 0.75 percent by weight of pectin, about 0 to 0.5 percent by weight of citric acid, about 0 to 0.3 percent by weight of sodium citrate, about 0 to 0.3 percent by weight of calcium citrate, and about 0 to 0.06 percent phosphate, together with such other ingredients as may be conventionally used in such filling.

In one embodiment of the invention, the filling comprises at least about 0.01 percent by weight of gluten and less than about 10 percent by weight of gluten. In another, the filling comprises from about 0.1 to 5.0 percent by weight of gluten. In a preferred embodiment, the gluten is deamidated gluten.

The invention further relates to a method of producing a fruit filling comprising the steps of: (a) boiling about 2 kilograms of crushed fruit; (b) adding 100 grams of pectin; (c) adding about 2 kilograms of sugar admixed with about 20 grams of deamidated gluten to the boiling mixture of (b); and (d) cooling the product of (c) so as to produce a fruit filling with reduced flowability and stickiness that is pumpable at room temperature, whereby the weights and quantities indicated are by way of example only, and may be adjusted as required or scaled up or down as necessary for a given situation.

The invention further relates to a nutritional bar comprising a confectionery layer, which is sometimes referred to as a “dry layer,” and a fruit filling layer, wherein the fruit filling comprises fruit puree and wheat gluten. The confectionery layer may comprise peanut flour and the bar may be enrobed by chocolate or a compound coating material, including a high protein compound coating material. In another embodiment, the confectionery layer may comprise high protein dough.

### DESCRIPTION OF THE DRAWINGS

FIG. 1 is a schematic of slab forming process.

### DETAILED DESCRIPTION OF THE INVENTION

It has now been discovered that the addition of wheat gluten to conventional fruit fillings can confer the physical properties that are required for use as layering materials in nutritional bars, by conferring thixotropicity and by giving good stand-up behavior and resistance to flow, yet are indistinguishable in appearance, texture and taste from unmodified fillings, are less sticky, and can be pumped at room temperature.

“Pumpability” can be ascertained using a murzon piston-based vacuum pump. However, most pumps as used in the industry for pumping viscous thixotropic liquids could be calibrated as a reference point. “Stand-up ability” relates to “flowability”. If part of a layer is cut into a piece, flowability is assessed by determining whether that piece retains its shape without the edges gradually becoming rounded and the piece flattening and flowing to cover a larger area. “Stickiness or tack” is the quality assessed by applying pressure to the filing and observing whether the filling adheres the objected used to apply pressure. It is common to use an oiled knife for this purpose but other objects, including a finger would be appropriate, as well. Those of skill in the art would appreciate that other methods for assessing the above qualitative features are known and available.

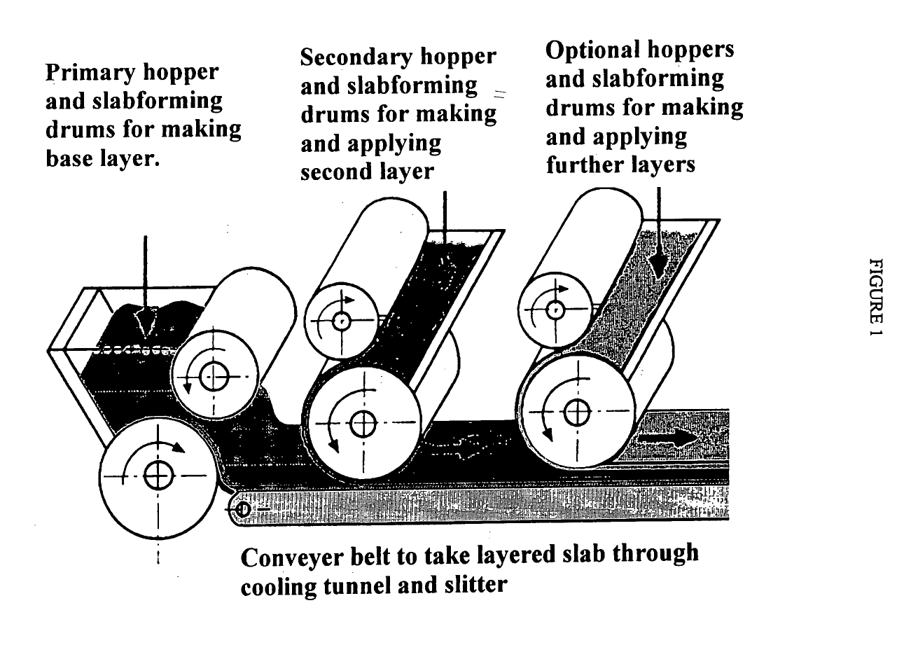

A “layering” material is a substance that can be made into a layer or sheet via some forming process such as rolling, extrusion through slits or slots, depositing and removal from refrigerated drums, pressing between plates, insertion into molds, or combinations of the above. The layering materials can be used on the top, middle or bottom of a bar. FIG. 1 shows one such layering process, the slab process.

The fillings according to the invention, also may be used to replace some or all of the concentrated carbohydrate liquids traditionally used in the manufacture of nutritional bars. When used in this way, the fillings confer improved flavor, texture and stability on such nutritional bars.

Specific nomenclature may be used to designate the various types of fruit filling that may be prepared from fruits. Jelly is the gelled fruit juice with little or no solid material, and is usually quite clear. The terms “jam” and “preserve” are practically synonymous in that both types of product contain pieces of fruit; preserves are considered to have slightly larger pieces of particulate material than jams, but there is no clear line of demarcation. Conserves are often defined as preserves with added nuts, while marmalades are citrus-based preserves.

Thus, the present invention relates to a fruit filling comprising fruit puree and wheat gluten. The fruit puree of the present invention comprises crushed fruit, pectin and sugar. Such fillings may contain additional materials that are traditionally or conventionally used in their manufacture, including, but not limited to, water, sucrose, other mono- or di-saccharides, sugar alcohols, oligosaccharides, other carbohydrates, fruit, pectin, alginates, citric acid, sodium citrate, calcium citrate, sodium pyrophosphate, acid phosphates, emulsifiers, flavors, and the like. In one embodiment, the filling of the invention comprises at least one additional ingredient that may conventionally be used in such fillings and would be known to those skilled in the art.

Typical ranges for the content of such additional materials are exemplified below but are not limiting:

| Component: | Range: |
|---|---|
| Water | 0%-25% |
| Sugar | 0%-65% |
| Fruit | 0%-62% |
| Pectin | 0%-2.75% |
| Citric acid | 0%-0.5% |
| Sodium alginate | 0%-0.5% |
| Sodium citrate | 0%-0.3% |
| Calcium citrate | 0%-0.32% |
| Phosphate | 0%-0.06% |

For diabetic or low sugar products, the sugar may be replaced by sorbitol, fructose, and other sugar substitutes known to the skilled artisan.

One skilled in the art would understand that many different fruits are suitable for use in the present invention. For instance, the fruit could be any type of berry, such as a blueberry, strawberry or raspberry, or it could be an apple, apricot, peach, or cherry.

The types of gluten that may be used are both vital and devitalized, and use of deamidated wheat gluten is of particular merit. Therefore the invention provides fruit fillings which set conventionally, yet possess adequate stand-up properties and resistance to flow, such that they may be applied at room temperature as a layer on a confectionery base which may then be slit into ribbons and guillotined to form nutritional bars. Methods of producing nutritional bars are known to the skilled artisan.

Gluten Proteins are storage proteins of wheat that are unique because they also are functional proteins. They do not have enzyme activity, but they are the only cereal proteins to form a strong, cohesive dough that will retain gas and produce light baked products. They can be easily isolated by removing starch and albumins/globulins by gently working a dough under a small stream of water. After washing, a rubbery ball is left, which is called gluten. After dispersion in water, this can be dried by flash-drying or spray-drying to give vital gluten, which retains its functional properties, or it may be dried under harsher conditions to give devitalized gluten. Devitalized gluten may also be obtained by enzymatic hydrolysis. Gluten is composed of two main groups of proteins: gliadins (prolamins) and glutenins (glutelins) in a ratio of approximately 2:3.

Wheat gluten is available as a by-product of the wheat starch industry and is used in food applications. The insolubility of gluten in aqueous solutions is one of the major limitations for its more extensive use in food processing. Gluten insolubility is due to the high concentration of nonpolar amino acid residues such as proline and leucine and the polar but non-ionisable residue glutamine, and to the low concentration of ionisable side chains such as lysine, arginine, glutamic acid and aspartic acid. The interactions between glutamine and asparagine side chains through hydrogen bonds play an important role in promoting association of gliadin and glutenin molecules to give the functionally complete gluten, and therefore modulation of these interactions are important for modification of gluten functionality.

Methods for modifying the solubility and functional properties of gluten have been developed. In particular, gluten modification via deamidation can be achieved in two ways, namely chemical deamidation (acid solubilisation) under acidic conditions and high temperature (Wu et al., 1976) or enzymatic treatment (Kato et al., 1987; Bollecker et al., 1990; Popineau and Thebaudin, 1990). Whether chemically or enzymatically induced, the deamidation of gluten proteins results in an increased charge density on the protein, causing changes in protein conformation due to electrostatic repulsion. These charge-induced conformational changes resulted in enhanced surface hydrophobicity due to the exposure of hydrophobic residues (Matsudomi et al., 1982). The increased surface hydrophobicity coupled with the presence of more negatively charged polar groups results in a modified protein with amphiphilic characteristics which makes an ideal surface active agent for use as an emulsifier or foam stabilizer. Even though surface hydrophobicity increases, protein solubility is also enhanced due to decreased protein-protein interactions. Levels of deamidation as low as 2-6% can enhance the functional properties of proteins (Matsudomi et al., 1985; Hamada and Marshall, 1989). Acid deamidation has been reported to leave behind an astringent mouth-feel, although this can be overcome by extraction with alkaline isopropanol and then isopropanol after deamidation (Finley, 1975). Deamidation is a hydrolytic reaction, similar to the peptide-bond cleavage reaction, which is catalyzed by proteases. It is catalyzed by acids and bases (nucleophiles), and requires a water molecule. The general acid, HA, catalyses the reaction by protonating the amido —NH— leaving group of the Asn side chain. A general base (the conjugate base, A- or hydroxide ion) can attack the carbonyl carbon of the amido group or activate another nucleophile by abstraction of a proton for attack on the amide carbon. The transition state is inferred to be an oxyanion tetrahedral intermediate, whose stabilization by proton donors increases the rate of the reaction. The order of acid- and base-catalyzed steps varies with reaction conditions, particularly pH. The pH of maximum stability of Asn and Gln in peptides is around pH 6.0. Wright and Robinson (1982) showed how specific amino acid side chains are likely to function in catalyzing the deamidation of Asn and Gln in peptides and proteins. The Ser and Thr side chains can function as general acid groups, providing a proton to the leaving group or stabilizing the transition state. Asp, Glu, and His side chains are all nucleophiles at neutral pH, which can attack the carbonyl carbon of the amide side chain or function as general bases to activate nucleophiles.

The fruit fillings according to the invention may contain at least about 0.01% gluten but they may contain up to about 10% gluten, which may either be vital, devitalized or deamidated. In a preferred embodiment, the level of gluten incorporation is about 0.1%-5.0%, and deamidated gluten is preferred.

Another embodiment of the present invention relates to a method of producing a fruit filling comprising the steps of boiling crushed fruit, adding 100 grams of pectin, adding sugar admixed with about 20 grams of deamidated gluten to the boiling mixture and cooling the product so as to produce a fruit filling with reduced flowability and stickiness that is pumpable at room temperature, whereby the weights and quantities indicated are by way of example only, and may be adjusted as required or scaled up or down as necessary for a given situation.

In one embodiment, the invention relates to a confectionary bar or a nutritional bar. A nutritional bar is one that may be used as a dietary supplement or as a meal replacement. Nutritional bars may contain vitamins, minerals and other elements.

In another embodiment, the invention relates to a bar comprising a confectionery layer and a fruit filling layer, wherein the said fruit filling comprises fruit puree and wheat gluten. The confectionery layer may comprise any confectionery layer that would be desired by one skilled in the art, and may, for example and without limitation, comprise a dough that can be formed into a layer containing various proteins, carbohydrates (as powdered ingredients or as concentrated liquids), peanut flour, cocoa powder, oils and fats, or particulate materials such as peanuts, soy beans, crisped rice, crisped soy protein or soy flour, and flavors. The bar may or may not be enrobed with a coating material such as a chocolate coating, optionally containing added protein, or a compound coating, which compound coatings may optionally comprise added proteins, and which may have the attributes of a chocolate, yogurt, peanut, carob or other type of coating material.

In one embodiment, the confectionery layer of the invention may be carbohydrate, protein or a combination of both. In one example, the carbohydrate may be digestible carbohydrate alone or a mixture of digestible and poorly digestible carbohydrate or non-digestible carbohydrates or it may comprise only poorly digestible carbohydrate. The carbohydrate may be added as a solid, dry material or it may be used in a concentrated solution.

The protein may be a binding protein, filler protein or mixtures thereof. A binding protein may be any protein which has low absorption properties yet will emulsify and can create a matrix of hydration. Specific examples are soy proteins, whey protein, whole milk protein, pea protein, egg albumen and wheat gluten.

Filler proteins may be any protein which has been denatured by processing to a low level of functional activity. Examples of filler proteins are caseinates, certain types of soy or whey proteins, pea protein, wheat gluten and egg albumens. Filler proteins should have low functionality and low water absorption and low viscosity, in particular.

Binding and filler proteins are known to the skilled artisan and are further described in U.S. Pat. No. 6,432,457, which is hereby incorporated by reference.

In one example, the confectionery layer comprises a high protein dough. High protein doughs, wherein the percentage by weight of protein is higher than that of carbohydrate are described in U.S. Pat. Nos. 6,299,929 and 6,432,457, which are again incorporated herein by reference.

The bar of the present invention may be prepared by any method known to the skilled artisan. Such methods include but are not limited to cold extrusion methods. In one embodiment, a blend of confectionery materials is prepared in a dough mixer, and mixed until homogenous. A blend of liquids and fats is then made in a liquid mixer, such as a large Hobart mixer and stirring at high speed until homogenous. The liquid blend is then added to the powder blend in the dough mixer and further mixed until a homogenous plastic dough is obtained. This dough is placed in the hopper of a slab former, such as those manufactured by the German company Sollich, and passed between two drums, which may be cooled or warmed as required, and which for convenience may be referred to further in this specification as a “slabbing head”, to form a thin slab of material that is approximately as wide as the drum, for example 30″, though such equipment may be obtained in sizes capable of making slabs from a few inches to several feet wide. This slab is deposited on a moving conveyer belt such that it moves away from the forming drums at a speed corresponding to the rate of formation. At the same time, the fruit puree with gluten blend is optionally warmed, for example to 30° C. to 45° C., and is applied to a third cooled drum rotating just above the moving slab of dough, such that a thin slab of fruit filling is continuously formed at a rate identical to that of the base slab, that can be separated from the drum and caused to adhere to the slab of dough, giving a slab of two layers, namely dough underneath and fruit filling on top, whereby the thicknesses of the two layers may be adjusted by firstly adjusting the gap between the drums which form the base layer, and secondly by adjusting the amount of material applied to the third roller, for example, by increasing or decreasing the gap between an optional hopper and the third roller, or if the material is applied directly from a pump, by adjusting pumping rate. The composite slab thus prepared is passed through a cooling tunnel, and then slit into ribbons by a set of rotating circular knives, the distance between which defines the width of the eventual bar. These ribbons are subsequently guillotined into bars of the required weight, which may, for example, be about 40 grams each, which are enrobed with a coating material as described above, for example a high protein compound chocolate coating, to give finished bars of about 50 grams, whereby it is understood that the weight and size of the bars are not limiting and may readily be adjusted as required. The bars are then wrapped in a Mylar foil. As will be obvious to a skilled artisan, it is also possible to move the drum that applies the fruit filling layer to a position in front of the confectionery slabbing layer, such that the fruit filling layer will eventually become the base layer of the finished bar. The skilled artisan would understand that adjustments can be made in the above steps and that other methods are known and available to the skilled artisan.

Preferably, the bars of the present invention are two-layer or multi-layer bars in which one of the layers is the fruit filling of the invention, whereby any enrobing is not considered as a layer. In one embodiment, multi-layer bars are made according to the process described above, but with additional “slabbing heads” and/or one or more additional drums rotating above the layer of slabbed dough, whereby such drums may be used to apply further layers of fruit filling or layers of confectionery material, such that further layers are consecutively added to the base slab as it proceeds away from the initial “slabbing head”. In a further embodiment, one or more of the layers may consist of particulate material that is sprinkled onto the slab or composite slab using equipment conventionally known as a nut or seed spreader, and which subsequently may or may not be covered by a further layer.

While the foregoing describes an embodiment whereby the bars according to the invention are manufactured by slab forming, it is also possible to manufacture such items using cold formers known as extruders with specially constructed dies, whereby the various layers are fed simultaneously to dies with internal divisions such that multiple thin “ropes” or strands of layered material are produced that can subsequently by guillotined or cut into bars. Such equipment is manufactured, for example, by the German company Bepex-Hutt, and though such equipment has limited capability for multilayer bars, it offers the capability of creating a bar in which the layers are concentric, that is, the fruit filling layer may be surrounded by a concentric layer of confectionery material or vice versa.

The following references are hereby incorporated by reference in their entirety.

### References

Bollecker, S., Viroben, G., Popineau, Y. and Gueguen, J. (1990). Acid deamidation and enzymic modification at pH 10 of wheat gliadins: influence on their functional properties. Sci. Aliments 10; 343-356.

Finley, J. W. (1975). Deamidated Gluten: Apotential fortifier for fruitjuices. J. Food Sci. 40; 1283-1285.

Hamada, J. S. and Marshall, W. E. (1989). Preparation and functional properties of enzymatically deamidated soy proteins. J. Food Sci. 54; 598-601

Kato, A., Tanaka, A., Lee, Y., Matsudomi, N. and Kobayashi, K. (1987). Effects of deamidation with chymotrypsin at pH 10 on the functional properties of proteins. J. Agric. Food Chem. 35; 285-288.

Matsudomi, N., Kato, A. and Kobayashi, K. (1982). Conformational and surface properties of deamidated gluten. Agric. Biol. Chem. 46; 1583-1586.

Matsudomi, N., Sasaki, T., Kato, A. and Kobayashi, K. (1985). Conformational changes and functional properties of acid-modified soy protein. Agric. Biol. Chem. 49; 1251-1256.

Popineau, Y. and Thebaudin, J. Y. (1990). Functional properties of enzymatically hydrolyzed glutens. In “Gluten Protein” (Eds. Bushuk, W. and Tkachuk, R.), AACC: St Paul, Minn.

Wright, H. T. and Robinson, A. B. (1982). Cryptic amidase active sites catalyze deamidation in proteins. In: “From Cyclotrons to Cytochromes”. (Eds. Kaplan, N. O. and Robinson, A. B.), Academic Press, New York.

Wu C. H., Shuryo, N. and Powrie, W. D. (1976). Preparation and properties of acid solubilized gluten. J. Agric. Food Chem. 24; 504-510.

### EXAMPLES

The invention is illustrated without limitation by the following examples.

### Example 1

A blueberry preserve was made from 2 kg blueberries. The blueberries were first crushed, 25 ml lemon juice was added, and 100 grams of apple pectin was stirred into the resultant puree. The mixture was boiled, and 2 kg sugar was quickly added while the heat was maintained. The mixture was boiled for a further 60 seconds, then divided into two parts of approximately 2 kg each.

Both parts were allowed to cool. At about 35° C., 20 grams of deamidated wheat gluten was added to one part, and stirred in. The two parts were then allowed to cool to room temperature.

Both parts set similarly and were of identical appearance. However, while the blueberry filling without gluten flowed when 50 grams was placed on a flat plate, the material with gluten showed little or no flow.

### Example 2

A commercial apple filling of the composition shown below, 1 kg, was warmed to 35° C., and 10 grams of deamidated wheat gluten was stirred in. Upon cooling, and in comparison with an untreated sample of the apple filling, the treated material showed essentially no flowability at room temperature, and could be formed into sheets of about 1 cm in thickness which were flexible and non-sticky.

The composition of this filling was:

| Ingredient: | Percentage composition: |
|---|---|
| High fructose corn syrup | 37.000 |
| Apple puree | 33.000 |
| Water | 15.000 |
| Apple powder | 12.000 |
| Pectin | 1.500 |
| Natural flavor | 1.000 |
| Malic acid | 0.500 |

### Example 3

A commercial raspberry filling of the composition shown below, 1 kg, was warmed to 35° C., and 10 grams of deamidated wheat gluten was stirred in. Upon cooling, and in comparison with an untreated sample of the raspberry filling, the treated material showed essentially no flowability at room temperature, and could be formed into sheets of about 1 cm in thickness which were flexible and non-sticky. Apart from this property, there was no difference in appearance between the two samples.

| Ingredient | Percentage Composition: |
|---|---|
| Sugar | 40.600 |
| Raspberries | 30.700 |
| Dextrose | 25.200 |
| Pectin | 2.200 |
| Citric acid | 0.600 |
| Sodium citrate | 0.400 |
| Natural flavor | 0.300 |

### Example 4

The procedure of Example 3 was repeated using a vital wheat gluten. Again, the treated sample showed little flowability in comparison with the untreated sample.

### Example 5

A “peanut butter/jelly” two layer nutritional bar was made as follows:

A blend of confectionery materials was prepared in a low-shear dough mixer, according to the following composition, and mixed until homogenous.

| INGREDIENT: | WEIGHT IN KILOGRAMS: |
|---|---|
| Acid casein | 8.481 |
| Peanut pieces | 6.051 |
| Gelatin powder | 5.855 |
| Soy protein isolate | 3.370 |
| Whey protein isolate | 6.184 |
| Peanut flour | 1.739 |
| Salt | 0.208 |

A blend of liquids and fats was made according to the composition below, by placing the indicated amounts of materials in a large Hobart mixer and stirring at high speed until homogenous.

| INGREDIENT: | WEIGHT IN KILOGRAMS: |
|---|---|
| Glycerine | 9.810 |
| Maltitol syrup | 3.059 |
| Corn syrup | 2.213 |
| Water | 1.142 |
| Peanut butter | 1.199 |
| Flavors | 1.717 |
| Special fat preparation | 0.470 |
| Lecithin | 0.297 |

The liquid blend was then added to the powder blend in the dough mixer and further mixed until a homogenous plastic dough was obtained. This dough was placed in the hopper of a Sollich slab former and passed between two cooled drums to form a thin slab of material approximately 30″ wide. At the same time, the raspberry preserve with gluten blend of Example 3 was warmed to 35° C. and was applied to a third cooled drum rotating just above the slab of dough, such that a thin slab of fruit preserve was formed that could be separated from the drum and caused to adhereto the slab of dough, giving a slab of two layers, namely dough underneath and fruit preserve on top, of approximately equal thicknesses. The composite slab thus prepared was passed through a cooling tunnel, and then slit into ribbons by a set of rotating circular knives. These ribbons were subsequently guillotined into bars of about 40 grams each, which were enrobed with a high protein compound chocolate coating to give finished bars of about 50 grams. The bars were wrapped in a Mylar foil.

The nutritional profile of these bars was:

Nutritional information per 50 gram unit:

| NUTRIENT: | CONTENT: | |
|---|---|---|
| Protein | 14.200 | g |
| Carbohydrate, total | 22.600 | g |
| Fat | 5.920 | g |
| Moisture | 5.900 | g |
| Total dietary fiber | 1.140 | g |
| Kilocalories (Atwater) | 193 | Kcal |
| Kilojoules | 809 | Kj |
| Cholesterol | 1 | mg |
| Saturated fat | 2.990 | g |
| Mono-unsaturated fat | 1.460 | g |
| Poly-unsaturated fat | 1.000 | g |
| Total omega-3 EFAs | 0.060 | g |
| Total omega-6 EFAs | 0.940 | g |
| Linoleic acid | 0.940 | g |
| Potassium | 80 | mg |
| Sodium | 85 | mg |
| Calcium | 67 | mg |
| Phosphorus | 129 | mg |

### Example 6

A blend of liquids and fats was made according to the composition below, by placing the indicated amounts of materials in a large Hobart mixer and stirring at high speed until homogenous. The filling was warmed to 30° C. before adding.

| INGREDIENT: | WEIGHT IN KILOGRAMS: |
|---|---|
| Raspberry filling (Example 3) | 32.729 |
| Almond butter | 8.576 |
| Honey | 8.044 |
| Lecithin | 0.894 |
| Flavor | 0.515 |

A blend of confectionery materials was prepared in a low-shear dough mixer, according to the following composition, and mixed until homogenous.

| INGREDIENT: | WEIGHT IN KILOGRAMS: |
|---|---|
| Soy nuggets | 20.864 |
| Soy bean pieces | 18.144 |
| Soy protein isolate | 6.259 |
| Peanut flour | 3.974 |

The liquid blend was then mixed with the blended powders and further mixed until a dough was obtained. This dough was placed in the hopper of a 16″ APV confectionery former and shaped into ribbons (cross-section 1.25″×0.625″) which were guillotined to give bars of about 50 grams each. After cooling, the bars were immediately wrapped in foil, without enrobing, to give a nutritious protein snack. The texture of the bars was significantly improved over that of comparable bars made without filling.

The nutritional profile of the bars was as indicated.

Nutritional information per 50 gram unit:

| NUTRIENT: | CONTENT: | |
|---|---|---|
| Protein | 15.240 | g |
| Carbohydrate, total | 21.780 | g |
| Fat | 5.310 | g |
| Moisture | 5.960 | g |
| Total dietary fiber | 2.490 | g |
| Kilocalories (Atwater) | 187 | Kcal |
| Kilojoules | 782 | Kj |
| Cholesterol | 0 | mg |
| Saturated fat | 0.800 | g |
| Mono-unsaturated fat | 2.230 | g |
| Poly-unsaturated fat | 2.010 | g |
| Total omega-3 EFAs | 0.200 | g |
| Total omega-6 EFAs | 1.810 | g |
| Linoleic acid | 1.805 | g |
| Potassium | 185 | mg |
| Sodium | 207 | mg |
| Calcium | 46 | mg |
| Phosphorus | 123 | mg |

1. A fruit filling comprising fruit puree and wheat gluten.

2. The filling of claim 1, wherein said fruit puree comprises crushed fruit, pectin and sugar.

3. The filling of claim 2, wherein said filling comprises at least one additional ingredient selected from the group consisting of water, citric acid, sodium citrate, calcium citrate and phosphate.

4. The filling of claim 1, wherein said fruit puree comprises crushed fruit, pectin and sorbitol or fructose.

5. The filling of claim 1, wherein said wheat gluten is deamidated.

6. The filling of claim 2, wherein said crushed fruit is selected from the group consisting of blueberry, apple, apricot, peach, strawberry, blackberry, grape, cherry, and raspberry crushed fruit.

7. The filling of claim 1, further comprising about 0 to 25 percent by weight of water, about 0 to 66 percent by weight of sugar, about 0 to 62 percent by weight of fruit, about 0 to 0.75 percent by weight of pectin, about 0 to 0.5 percent by weight of citric acid, about 0 to 0.3 percent by weight of sodium citrate, about 0 to 0.3 percent by weight of calcium citrate, and about 0 to 0.06 percent phosphate.

8. The filling of claim 1, which comprises at least about 0.01 percent by weight of gluten.

9. The filling of claim 8, wherein said filling comprises less than about 10 percent by weight of gluten.

10. The filling of claim 9, wherein said filling comprises from about 0.1 to 5.0 percent by weight of gluten.

11. The filling of claim 10, wherein said gluten is deamidated gluten.

12. A method of producing a fruit filling with reduced flowability comprising the steps of: (a) boiling about 2 kilograms of crushed fruit; (b) adding about 100 grams of pectin to (a); (c) mixing about 2 kilograms of sugar with about 20 grams of deamidated gluten; (d) adding the mixture of (c) to the mixture of (a) and (b); and (e) cooling the product of (d) to about 35 degrees centigrade, so as to produce a fruit filling that retains its form without spreading, flattening or flowing once shaped by cutting.

13. A bar comprising a confectionery layer and a fruit filling layer, wherein said fruit filling comprises fruit puree and wheat gluten.

14. The bar, wherein said confectionery layer comprises peanut flour.

15. The bar of claim 7, which is enrobed with high protein chocolate.

16. The bar of claim 13, which is a nutritional bar.

17. The bar of claim 13, which further comprises other filling or confectionery layers.

18. The bar of claim 16, which further comprises nutritional additives selected from the group consisting of vitamins, minerals and elements.

19. The bar of claim 16, wherein the confectionery layer comprises a high protein dough.
